(19) United States
(12) Patent Application Publication
(10) Pub. No.: US 2012/0020432 A1
(43) Pub. Date: Jan. 26, 2012

(54) METHOD FOR ESTIMATING MIMO CHANNEL USING LOOSELY SYNCHRONOUS CODES, AND APPARATUS USING THE SAME

(75) Inventors: Won Sop Kim, Daejeon (KR); Jae Joon Park, Daejeon (KR); Myung Don Kim, Daejeon (KR); Hyun Kyu Chung, Daejeon (KR)

(73) Assignee: ELECTRONICS AND TELECOMMUNICATIONS RESEARCH INSTITUTE, Daejeon (KR)

(21) Appl. No.: 12/672,741

(22) PCT Filed: Aug. 8, 2008
(86) PCT No.: PCT/KR2008/004610

§ 371 Date: Feb. 9, 2010

(30) Foreign Application Priority Data
Aug. 14, 2007 (KR) 10-2007-0081641
Nov. 2, 2007 (KR) 10-2007-0111721

(51) Int. Cl. H04L 27/06; H04L 25/49

(52) U.S. Cl. 375/296; 375/343

(57) ABSTRACT

Disclosed are a method and apparatus for estimating a Multiple Input Multiple. Output (MIMO) channel. A signal transmission method for estimating the MIMO channel via 2N transmission antennas (N is greater than or equal to “1”) includes generating a code having a predetermined Interference Free Window (IFW), and transmitting the code via two transmission antennas.

### TECHNICAL FIELD

The present invention relates to a method and apparatus for estimating a Multiple Input Multiple Output (MIMO) channel, and more particularly, to a method and apparatus for estimating a MIMO channel, which simultaneously transmits a Loosely Synchronous (LS) code via two or four transmission antennas, thereby reducing a channel estimation time and improving accuracy of the channel estimation.

This work was supported by the IT source technology development program of MIC/IITA. [2005-S-001-03, Development of Wireless Vector Channel Model for next generation mobile communication]

### BACKGROUND ART

Performance of a Multiple Input Multiple Output (MIMO) system is significantly influenced by a channel environment, and thus an accurate channel estimation is required in order to use the MIMO system.

Accordingly, a MIMO channel estimation apparatus such as a MIMO channel sounder is required to provide channel information suitable for a system design.

A MIMO channel estimation according to a conventional art is performed using a Pseudo Noise (PN) code. In the conventional MIMO channel estimation using the PN code, the PN code is sequentially transmitted from each transmission antenna only during a given time interval so as to remove interference between multiple antennas.

However, in the conventional MIMO channel estimation using the PN code, another channel being significantly different with a real channel is estimated in the case where the PN code is lengthened or a number of transmission antennas increases.

Also, in a MIMO channel estimation according to another conventional art, a subcarrier is assigned to each transmission antenna in a frequency domain to thereby simultaneously estimate a channel.

However, since the subcarrier capable of being assigned to the each transmission antenna is restricted in the channel estimation using the subcarrier, a number of transmission antennas cannot be increased to be greater than a predetermined number, and also a complex system is disadvantageously required in order to restore a channel in a receiving end.

### DISCLOSURE OF INVENTION

### Technical Problem

An aspect of the present invention provides a method and apparatus for estimating a Multiple Input Multiple Output (MIMO) channel.

An aspect of the present invention provides a method and apparatus for estimating a MIMO channel, which can simultaneously transmit a Loosely Synchronous (LS) code via two or four transmission antennas, thereby reducing a channel estimation time, and improving accuracy of the channel estimation.

### Technical Solution

According to an aspect of the present invention, there is provided a signal transmission method for estimating a Multiple Input Multiple Output (MIMO) channel via 2N transmission antennas (N is greater than or equal to ‘1’), which includes: generating a code having a predetermined Interference Free Window (IFW); and transmitting the code via two transmission antennas.

According to an aspect of the present invention, there is provided a method for estimating a MIMO channel, which includes: receiving a signal being simultaneously transmitted via two transmission antennas; and estimating a channel using autocorrelation or cross correlation of the received signal and a code having a predetermined IFW.

In this instance, the code having the predetermined IFW may be a pair of Loosely Synchronous (LS) codes.

In this instance, the received signal is received via a channel whose maximum delay time is less than ½ of the IFW.

According to an aspect of the present invention, there is provided a signal transmission method for estimating a MIMO channel via 4N transmission antennas (N is greater than or equal to ‘1’), which includes: generating a code having a predetermined IFW; and transmitting the code via four transmission antennas.

According to an aspect of the present invention, there is provided a method for estimating a MIMO channel, which includes: receiving a signal being simultaneously transmitted via four transmission antennas; and estimating a channel using autocorrelation or cross correlation of the received signal and a code having a predetermined IFW.

According to an aspect of the present invention, there is provided an apparatus for estimating a MIMO channel, which includes: an antenna for receiving a signal being simultaneously transmitted via two or four transmission antennas; a code storing unit for storing a code being identical to a code generated in a transmission end; and a channel estimation unit for estimating a channel using auto correlation and cross correlation of the received signal and the code stored in the code storing unit.

### BRIEF DESCRIPTION OF THE DRAWINGS

FIGS. 1 and 2 are graphs illustrating an Interference Free Window (IFW) in using autocorrelation and cross-correlation of a Loosely Synchronous (LS) code;

FIG. 3 is a block diagram illustrating each structure of transmitting/receiving ends of an apparatus for estimating a Multiple Input Multiple Output (MIND) channel according to an exemplary embodiment of the present invention;

FIG. 4 is a block diagram illustrating each structure of transmitting/receiving ends of an apparatus for estimating a MIMO channel according to another exemplary embodiment of the present invention;

FIG. 5 is a diagram illustrating transmitting/receiving frame structures of FIG. 3;

FIG. 6 is a diagram illustrating transmitting/receiving frame structures of FIG. 4;

FIG. 7 is a graph illustrating results of root mean square (RMS) Delay Spread error of a channel estimation apparatus when a speed of each receiving end is 0 Km/h;

FIG. 8 is a graph illustrating results of RMS Delay Spread error of a channel estimation apparatus when a speed of each receiving end is 120 Km/h; and

FIG. 9 is a graph illustrating results of RMS Delay Spread error of a channel estimation apparatus when a speed of each receiving end is 300 Km/h.

### MODE FOR THE INVENTION

Reference will now be made in detail to embodiments of the present invention, examples of which are illustrated in the accompanying drawings, wherein like reference numerals refer to the like elements throughout. The embodiments are described below in order to explain the present invention by referring to the figures.

A basic principle of the present invention is to use characteristics of a Loosely Synchronous (LS) code.

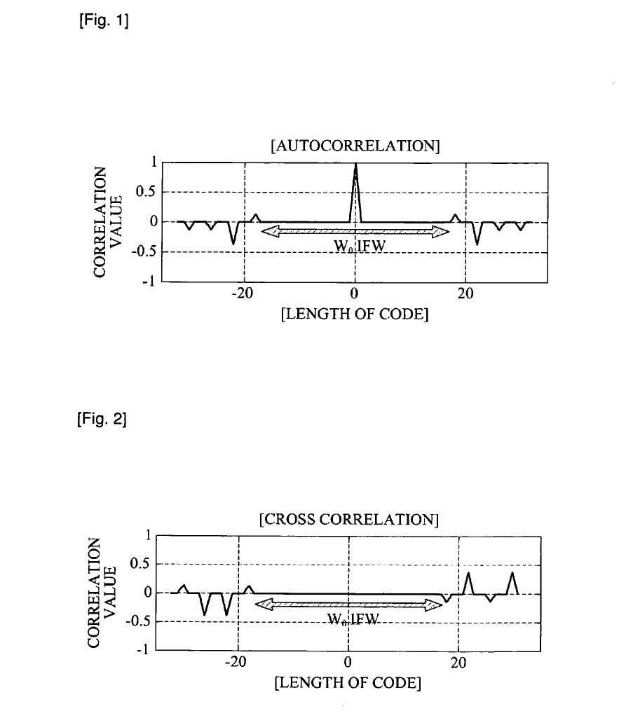

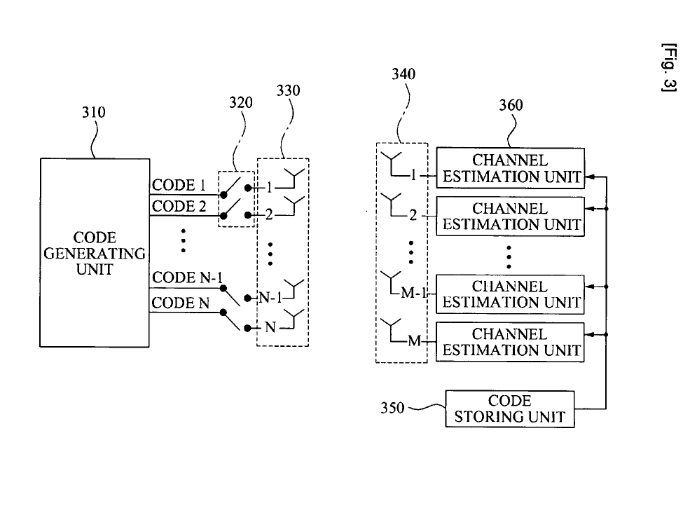

In general, in a Time-Division Multiplexing (TDM) system, the LS code has an Interference Free Window (IFW) as illustrated in FIGS. 1 and 2.

The LS code has characteristics in that each of an autocorrelation value and a cross correlation value of the LS code is ‘0’ in the IFW.

Accordingly, as illustrated in FIGS. 1 and 2, the LS code shows characteristics that the autocorrelation value is ‘0’ in a phase difference of a maximum of n-chips before and after ‘0’ with respect to ‘0’ of a phase difference.

Also, the cross correlation value is ‘0’ in a phase difference of −n to n. In this instance, the LS code may be referred to as having an IFW of [−n, n].

A number of LS codes is determined by a length of a code and IFW. When the length of a code is 32 chips, an overall number of LS codes is 32, however, all of the LS codes do not have an identical IFW.

For example, in the case of a LS code having a length of 32, two codes having an IFW of [−8, 8] exist. In this instance, the two codes are referred to as a pair of LS codes.

Also, since the cross correlation value of the LS code is ‘0’ in the IFW of [−n, n], the cross correlation value is ‘0’ even in the case of being not synchronized with signals of other users.

A method for estimating a Multiple Input Multiple Output (MIMO) channel according to the present exemplary embodiment is performed in a channel environment where a maximum delay time of the channel is less than IFW/2 or IFW/4 using the above-described characteristics of the LS code.

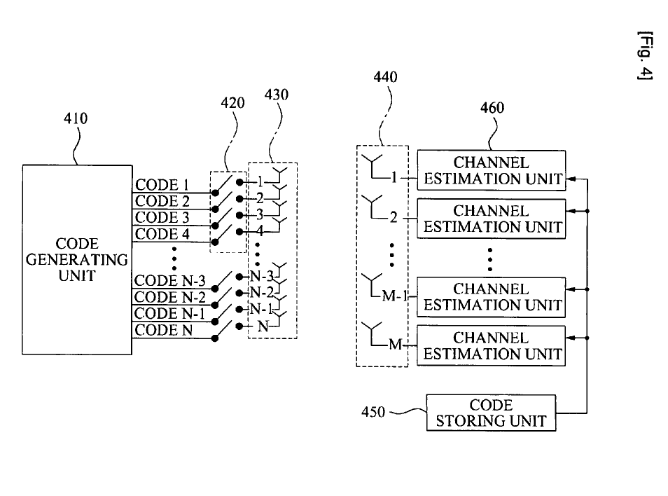

FIG. 3 is a block diagram illustrating each structure of transmitting/receiving ends of an apparatus for estimating a MIMO channel according to an exemplary embodiment of the present invention.

In FIG. 3, a maximum delay time of a channel is IFW/2.

Referring to FIG. 3, the transmitting end for estimating the MIMO channel includes a code generating unit 310 for generating a code having a predetermined IFW, and N antennas 330.

Also, the transmitting end for estimating the MIMO channel may further include a switch unit 320 for enabling the LS code to be sequentially transmitted via two of the N antennas 330 at a time.

Accordingly, the generated LS code is simultaneously transmitted via two of the N antennas 330.

Referring to FIG. 3, the receiving end for estimating the MIMO channel includes M antennas 340 for receiving signals simultaneously transmitted via two transmission antennas, a code storing unit 350 for storing the same LS code as generated in the transmitting end, and a channel estimation unit 360 for estimating a channel using autocorrelation and cross correlation of the LS code stored in the code storing unit 350 and also using autocorrelation and cross correlation of the received signals.

The receiving signals received via M antennas 340 may be represented by

$$\begin{matrix} {y}_{1} ( t ) = {h}_{1 , 1} ( τ , t ) * {c}_{1} ( t ) + {h}_{2 , 1} ( τ , t ) * {c}_{2} ( t ) + {w}_{1} ( t ) , \\ {y}_{2} ( t ) = {h}_{1 , 2} ( τ , t ) * {c}_{1} ( t ) + {h}_{2 , 2} ( τ , t ) * {c}_{2} ( t ) + {w}_{2} ( t ) , & [ Equation 1 ] \\ ⋮ \\ {y}_{M - 1} ( t ) = {h}_{1 , M - 1} ( τ , t ) * {c}_{1} ( t ) + {h}_{2 , M - 1} ( τ , t ) * {c}_{2} ( t ) + {w}_{M - 1} ( t ) , \\ {y}_{M} ( t ) = {h}_{1 , M} ( τ , t ) * {c}_{i} ( t ) + {h}_{2 , M} ( τ , t ) * {c}_{2} ( t ) + {w}_{M} ( t ) , & \end{matrix}$$

where ‘*’ denotes a convolution operation, (c₁(t), c₂(t)) denotes a pair of LS codes,

each of

h_{1,i}(τ,t)

and

h_{2,i}(τ,t)

denotes a channel, and

wⱼ

denotes an additive white Gaussian noise. In this instance, it is assumed that a number of transmission antennas is 2.

The channel estimation unit 360 estimates a channel using the receiving signals of Equation 1 and the same LS code as generated in the code generating unit 310.

The channel estimated by the channel estimation unit 360 may be expressed as

$$\begin{matrix}{\tilde{h}}_{1 , 1} = {R}_{{y}_{1} , {c}_{1}} ( m ) = {h}_{1 , 1} + {R}_{{h}_{2 , 1} * {c}_{2} , {c}_{1}} ( m ) + {R}_{{w}_{1} , {c}_{1}} ( m ) , \\ {\tilde{h}}_{2 , 1} = {R}_{{y}_{1} , {c}_{2}} ( m ) = {h}_{2 , 1} + {R}_{{h}_{1 , 1} * {c}_{1} , {c}_{2}} ( m ) + {R}_{{w}_{1} , {c}_{2}} ( m ) , \\ {\tilde{h}}_{1 , 2} = {R}_{{y}_{2} , {c}_{1}} ( m ) = {h}_{1 , 2} + {R}_{{h}_{2 , 2} * {c}_{2} , {c}_{1}} ( m ) + {R}_{{w}_{2} , {c}_{1}} ( m ) , \\ {\tilde{h}}_{2 , 2} = {R}_{{y}_{2} , {c}_{2}} ( m ) = {h}_{2 , 2} + {R}_{{h}_{1 , 2} * {c}_{1} , {c}_{2}} ( m ) + {R}_{{w}_{2} , {c}_{2}} ( m ) , & [ Equation 2 ] \\ ⋮ \\ \begin{matrix}{\tilde{h}}_{1 , M - 1} = {R}_{{y}_{M - 1} , {c}_{1}} ( m ) \\ = {h}_{1 , M - 1} + {R}_{{h}_{2 , M - 1} * {c}_{2} , {c}_{1}} ( m ) + {R}_{{w}_{M - 1} , {c}_{1}} ( m ) ,\end{matrix} \\ \begin{matrix}{\tilde{h}}_{2 , M - 1} = {R}_{{y}_{M - 1} , {c}_{2}} ( m ) \\ = {h}_{2 , M - 1} + {R}_{{h}_{1 , M - 1} * {c}_{1} , {c}_{2}} ( m ) + {R}_{{w}_{M - 1} , {c}_{2}} ( m ) ,\end{matrix} & \\ \begin{matrix}{\tilde{h}}_{1 , M} = {R}_{{y}_{M} , {c}_{1}} ( m ) \\ = {h}_{1 , M} + {R}_{{h}_{2 , M} * {c}_{2} , {c}_{1}} ( m ) + {R}_{{w}_{M} , {c}_{1}} ( m ) ,\end{matrix} \\ \begin{matrix}{\tilde{h}}_{2 , M} = {R}_{{y}_{M} , {c}_{2}} ( m ) \\ = {h}_{2 , M} + {R}_{{h}_{1 , M} * {c}_{1} , {c}_{2}} ( m ) + {R}_{{w}_{M} , {c}_{2}} ( m ) ,\end{matrix} & \end{matrix}$$

where

R_{a,a}(m)

denotes autocorrelation of ‘a’ and ‘a’, and

R_{a,b}(m)

denotes cross correlation of ‘a’ and ‘b’.

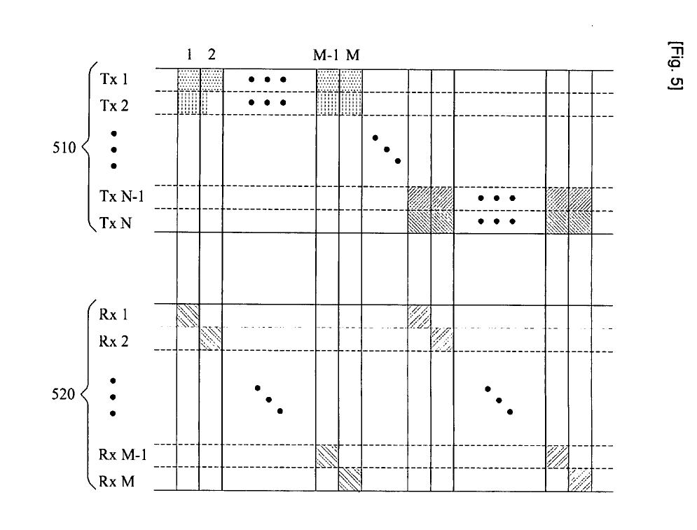

FIG. 4 is a block diagram illustrating each structure of transmitting/receiving ends of an apparatus for estimating a MIMO channel according to another exemplary embodiment of the present invention.

In FIG. 4, a maximum delay time of a channel is IFW/4.

Referring to FIG. 4, the transmitting end for estimating the MIMO channel includes a code generating unit 410 for generating a code having a predetermined IFW, and N antennas 430.

Also, the transmitting end for estimating the MIMO channel may further include a switch unit 420 for enabling the LS code to be sequentially transmitted via four of the N antennas 430 at a time.

Accordingly, the generated LS code is simultaneously transmitted via four of the N antennas 430.

Referring to FIG. 4, the receiving end for estimating the MIMO channel includes M antennas 440 for receiving signals simultaneously transmitted via four transmission antennas, a code storing unit 450 for storing the same LS code as generated in the transmitting end, and a channel estimation unit 460 for estimating a channel using autocorrelation and cross correlation of the LS code stored in the code storing unit 450 and also using autocorrelation and cross correlation of the received signals.

As illustrated in FIG. 4, the receiving signals received via the M antennas 440 may be represented by

y₁(t)=h_{1,1}(τ,t)*c₁(t)+h_{2,1}(τ,t)*c₂(t)+h_{3,1}(τ,t)*c₃(t)+h_{4,1}(τ,t)*c₄(t)+w₁(t),

y₂(t)=h_{1,2}(τ,t)*c₁(t)+h_{2,2}(τ,t)*c₂(t)+h_{3,2}(τ,t)*c₃(t)+h_{4,2}(τ,t)*c₄(t)+w₂(t),

y₃(t)=h_{1,3}(τ,t)*c₁(t)+h_{2,3}(τ,t)*c₂(t)+h_{3,3}(τ,t)*c₃(t)+h_{4,3}(τ,t)*c₄(t)+w₃(t),

y₄(t)=h_{1,4}(τ,t)*c₁(t)+h_{2,4}(τ,t)*c₂(t)+h_{3,4}(τ,t)*c₃(t)+h_{4,4}(τ,t)*c₄(t)+w₄(t),

y₅(t)=h_{1,5}(τ,t)*c₁(t)+h_{2,5}(τ,t)*c₂(t)+h_{3,5}(τ,t)*c₃(t)+h_{4,5}(τ,t)*c₄(t)+w₅(t),

y₆(t)=h_{1,6}(τ,t)*c₁(t)+h_{2,6}(τ,t)*c₂(t)+h_{3,6}(τ,t)*c₃(t)+h_{4,6}(τ,t)*c₄(t)+w₆(t),

y₇(t)=h_{1,7}(τ,t)*c₁(t)+h_{2,7}(τ,t)*c₂(t)+h_{3,7}(τ,t)*c₃(t)+h_{4,7}(τ,t)*c₄(t)+w₇(t),

y₈(t)=h_{1,8}(τ,t)*c₁(t)+h_{2,8}(τ,t)*c₂(t)+h_{3,8}(τ,t)*c₃(t)+h_{4,8}(τ,t)*c₄(t)+w₈(t), [Equation 3]

where ‘*’ denotes a convolution operation, (c₁(t), c₂(t)) denotes a first pair of LS codes, (c₃(t), c₄(t)) denotes a second pair of LS codes, each of

h_{1,i}(τ,t)

,

h_{2,i}(τ,t)

,

h_{3,i}(τ,t)

, and

h_{4,i}(τ,t)

denotes a channel, and

wⱼ

denotes an additive white Gaussian noise. In this instance, it is assumed that a number of transmission antennas is 4.

The channel estimation unit 460 estimates a channel using the receiving signals of Equation 3 and the same LS code as generated in the code generating unit 410.

The channel estimated by the channel estimation unit 460 may be expressed as

\tilde{h}_{1,1}=R_{y}_{₁}_{,c}_{₁}(m),\tilde{h}_{2,1}=R_{y}_{₁}_{,c}_{₂}(m),\tilde{h}_{3,1}=R_{y}_{₁}_{,c}_{₃}(m),\tilde{h}_{4,1}=R_{y}_{₁}_{,c}_{₄}(m),

\tilde{h}_{1,2:}=R_{y}_{₂}_{,c}_{₁}(m),\tilde{h}_{2,2}=R_{y}_{₂}_{,c}_{₂}(m),\tilde{h}_{3,2}=R_{y}_{₂}_{,c}_{₃}(m),\tilde{h}_{4,2}=R_{y}_{₂}_{,c}_{₄}(m),

\tilde{h}_{1,3.}=R_{y}_{₃}_{,c}_{₁}(m),\tilde{h}_{2,3}=R_{y}_{₃}_{,c}_{₂}(m),\tilde{h}_{3,3}=R_{y}_{₃}_{,c}_{₃}(m),\tilde{h}_{4,3}=R_{y}_{₃}_{,c}_{₄}(m),

\tilde{h}_{1,4}=R_{y}_{₄}_{,c}_{₁}(m),\tilde{h}_{2,4}=R_{y}_{₄}_{,c}_{₂}(m),\tilde{h}_{3,4}=R_{y}_{₄}_{,c}_{₃}(m),\tilde{h}_{4,4}=R_{y}_{₄}_{,c}_{₄}(m),

\tilde{h}_{1,5.}=R_{y}_{₅}_{,c}_{₁}(m),\tilde{h}_{2,5}=R_{y}_{₅}_{,c}_{₂}(m),\tilde{h}_{3,5}=R_{y}_{₅}_{,c}_{₃}(m),\tilde{h}_{4,5}=R_{y}_{₅}_{,c}_{₄}(m),

\tilde{h}_{1,6;}=R_{y}_{₆}_{,c}_{₁}(m),\tilde{h}_{2,6}=R_{y}_{₆}_{,c}_{₂}(m),\tilde{h}_{3,6}=R_{y}_{₆}_{,c}_{₃}(m),\tilde{h}_{4,6}=R_{y}_{₆}_{,c}_{₄}(m),

\tilde{h}_{1,7.}=R₇_{₁}_{,c}_{₁}(m),\tilde{h}_{2,7}=R_{y}_{₇}_{,c}_{₂}(m),\tilde{h}_{3,7}=R_{y}_{₇}_{,c}_{₃}(m),\tilde{h}_{4,7}=R_{y}_{₇}_{,c}_{₄}(m),

\tilde{h}_{1,8:}=R_{y}_{₈}_{,c}_{₁}(m),\tilde{h}_{2,8}=R_{y}_{₈}_{,c}_{₂}(m),\tilde{h}_{3,8}=R_{y}_{₈}_{,c}_{₃}(m),\tilde{h}_{4,8}=R_{y}_{₈}_{,c}_{₄}(m), [Equation 4]

where

R_{a,a}(m)

denotes autocorrelation of ‘a’ and ‘a’, and

R_{a,b}(M)

denotes cross correlation of ‘a’ and ‘b’.

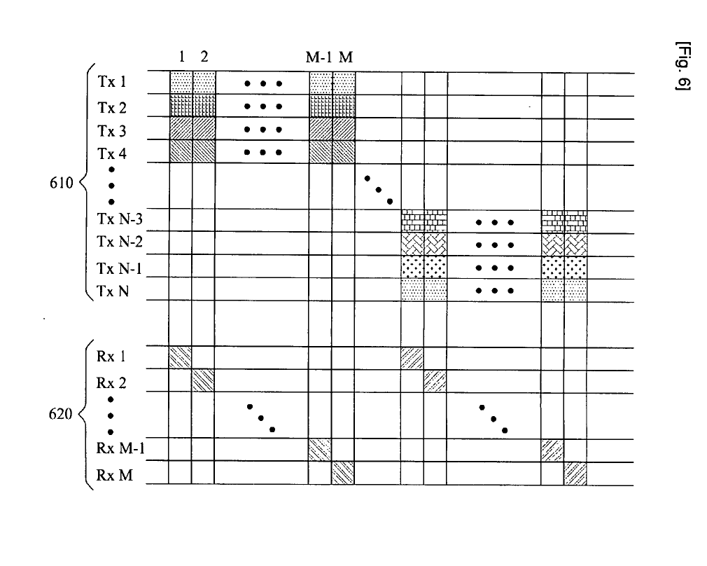

FIG. 5 is a diagram illustrating a transmitting frame structure 510 and a receiving frame structure 520 of FIG. 3, and FIG. 6 is a diagram illustrating a transmitting frame structure 610 and a receiving frame structure 620 of FIG. 4.

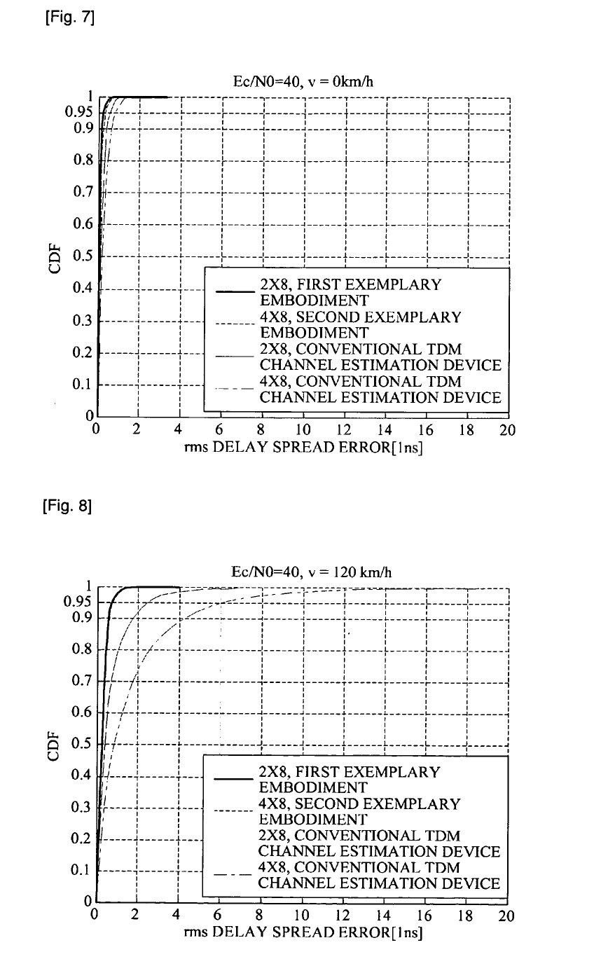

In FIGS. 7 to 9, simulation results with respect to rms Delay Spread error of a sounder when the transmitting end is fixed and each receiving end speed of is 0 Km/h, 120 Km/h, and 300 Km/h are shown. In this instance, a length of the LS code is 1024, and

### Wₒ

of IFW of the LS code is 512, and

### E_{c}/Nₒ

is 40 dB.

Also, a first exemplary embodiment corresponds to the exemplary embodiment of FIG. 3, and a second exemplary embodiment corresponds to the exemplary embodiment of FIG. 4. In this instance, it is assumed that the maximum delay time of the channel is

### Wₒ/2

and

### Wₒ/4

in each of the first and second exemplary embodiments. Also, each of the speed of the receiving end is 0 Km/h, 120 Km/h, and 300 Km/h, and each of a number of the transmitting/receiving antennas is

2×8

and

4×8

FIG. 7 is a graph illustrating results of rms Delay Spread error of a channel estimation apparatus when a speed of each receiving end is 0 Km/h.

In FIG. 7, a conventional

4×8

TDM sounder and a conventional

2×8

TDM sounder are a channel sounder of a TDM scheme according to a conventional art, respectively.

The channel estimation by the conventional channel sounder is difficult to be performed, and thus the performance is deteriorated. However, according to the present exemplary embodiment, a virtual channel is estimated, and thus the performance is improved.

FIG. 8 is a graph illustrating results of rms Delay Spread error of a channel estimation apparatus when a speed of each receiving end is 120 Km/h.

Referring to FIG. 8, when the speed of each receiving end is 120 Km/h, the performance of the conventional channel sounder is relatively deteriorated than when the speed of each receiving end is 0 Km/h in comparison with the channel estimation apparatuses according to the first and second exemplary embodiments.

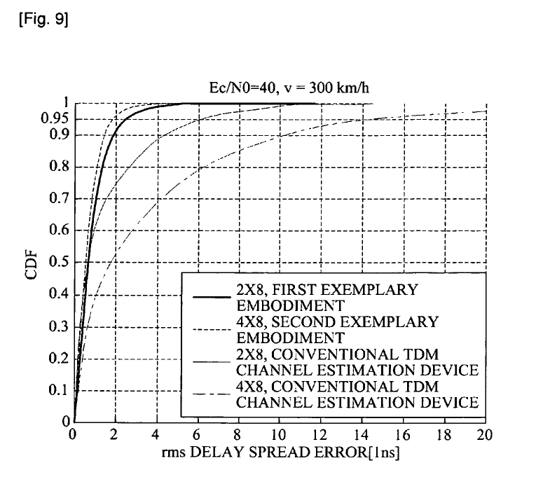

FIG. 9 is a graph illustrating results of rms Delay Spread error of a channel estimation apparatus when a speed of each receiving end is 300 Km/h.

Referring to FIG. 9, when the speed of each receiving end is 300 Km/h, the performance of the conventional channel sounder is significantly deteriorated than when the speed of each receiving end is 300 Km/h in comparison with the channel estimation apparatuses according to the first and second exemplary embodiments.

Also, as illustrated in FIGS. 8 and 9, the performance of the conventional channel sounder is deteriorated along with each increase in the number of transmitting/receiving ends.

The method for estimating the MIMO channel according to the above-described exemplary embodiments of the present invention may be recorded in computerreadable media including program instructions to implement various operations embodied by a computer. The media may also include, alone or in combination with the program instructions, data files, data structures, and the like. The media and program instructions may be those specially designed and constructed for the purposes of the present invention, or they may be of the kind well-known and available to those having skill in the computer software arts. Examples of computer-readable media include magnetic media such as hard disks, floppy disks, and magnetic tape; optical media such as CD ROM disks and DVD; magneto-optical media such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments of the present invention.

As described above, according to the first exemplary embodiment of the invention, the LS code is simultaneously transmitted via two of the transmission antennas at a time, thereby reducing a time required for estimating the entire MIMO channel by about ½ in comparison with a channel sounder of the conventional TDM scheme.

According to the second exemplary embodiment of the invention, the LS code is simultaneously transmitted via four of the transmission antennas at a time, thereby reducing a time required for estimating the entire MIMO channel by about ¼ in comparison with a channel sounder of the conventional TDM scheme.

According to the present invention, a virtual channel is estimated in comparison with the conventional method for estimating the MIMO channel. Also, the receiving end estimates the channel using autocorrelation or cross correlation of the LS code, and thus a configuration of the receiving end is simplified.

In particular, when it is assumed that a maximum delay time of the channel is less than ¼ of the IFW in a state where each of a number of antennas of the transmitting/receiving ends is relatively greater, and a speed of the receiving end is relatively fast, the channel estimation according to the second exemplary embodiment is performed more effectively than the channel estimation according to the first exemplary embodiment.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

1. A signal transmission method for estimating a Multiple Input Multiple Output (MIMO) channel via 2N transmission antennas (N is greater than or equal to ‘1’), the signal transmission method comprising:
generating a code having a predetermined Interference Free Window (IFW); and
transmitting the code via two transmission antennas.

2. The signal transmission method of claim 1, wherein the transmitting transmits the code via two of the 2N transmission antennas at a time.

3. A method for estimating a MIMO channel, the method comprising:
receiving a signal being simultaneously transmitted via two transmission antennas; and
estimating a channel using autocorrelation or cross correlation of the received signal and a code having a predetermined IFW.

4. The method of claim 3, wherein the code having the predetermined IFW is a pair of Loosely Synchronous (LS) codes.

5. The method of claim 3, wherein the received signal is received via a channel whose maximum delay time is less than ½ of the IFW.

6. A signal transmission method for estimating a MIMO channel via 4N transmission antennas (N is greater than or equal to ‘1’), the signal transmission method comprising:
generating a code having a predetermined IFW; and
transmitting the code via four transmission antennas.

7. The signal transmission method of claim 6, wherein the transmitting transmits the code via four of the 4N transmission antennas at a time.

8. A method for estimating a MIMO channel, the method comprising:
receiving a signal being simultaneously transmitted via four transmission antennas; and
estimating a channel using autocorrelation or cross correlation of the received signal and a code having a predetermined IFW.

9. The method of claim 8, wherein the code having the predetermined IFW is two pair of LS codes.

10. The method of claim 8, wherein the received signal is received via a channel with a maximum delay time of less than ¼ of the IFW.

11. An apparatus for estimating a MIMO channel, the apparatus comprising:
an antenna for receiving a signal being simultaneously transmitted via two or four transmission antennas;
a code storing unit for storing a code being identical to a code generated in a transmission end; and
a channel estimation unit for estimating a channel using auto correlation and cross correlation of the received signal and the code stored in the code storing unit.

12. The apparatus of claim 11, wherein the code being identical to the code stored in the transmission end is a pair of LS codes having a predetermined IFW.
